(19) United States
(12) Patent Application Publication
(10) Pub. No.: US 2026/0311127 A1
(43) Pub. Date: Oct. 8, 2026

(54) ARTIFICAL INTELLIGENCE ENABLED SMART INVENTORY MANAGEMENT, CHECK-OUT AND BILLING SYSTEM

(71) Applicants: Geeta Lalwani, Pune (IN); Paras Lalwani, Pune (IN)

(72) Inventors: Geeta Lalwani, Pune (IN); Paras Lalwani, Pune (IN)

(21) Appl. No.: 19/484,382

(22) PCT Filed: May 13, 2024
(86) PCT No.: PCT/IN2024/050524

§ 371 Date: Nov. 16, 2025

(30) Foreign Application Priority Data
May 17, 2023 (IN) 202321034647

(51) Int. Cl. G06Q 10/087; G06Q 20/18

(52) U.S. Cl. CPC G06Q 10/08772; G06Q 20/18

(57) ABSTRACT

Artificial intelligence enabled smart inventory management, self-check-out and billing system (100) comprises user device (200) with an application stored therein. System through its various components provide users about availability of the standard & loose pack products, location of the product, price per unit & promotional schemes, if any, once user is in geofenced store. The system allows the user to know in advance the bill amount for the items selected by them through their user device, provides return of the product selected at a defined location of the store, allows identification, weighing and pricing for non-standard pack/loose items and while check-out it cross checks the weight and items labels with the items selected by user and provides the alert in case of mismatch and make correction and then finally make payment and allow possession of items selected by user. System provides checks and balances related to errors/pilferage.

### FIELD

The present invention relates to an Artificial Intelligence Enabled Smart Inventory Management, Check-Out And Billing System that is capable of handling check-out and billing process of multi-products handling entities including supermarkets, libraries etc.

### DEFINITIONS

As used in the present disclosure, the following terms are generally intended to have the meaning as set forth below, except to the extent that the context in which they are used indicate otherwise.
Coded Information Label: It refers to the bar code, QR code or any similar type of including but not limited to RFID/2D or 3D labels/plates/tags which contains the requisite information as per commercial and legal practices whether affixed/printed by manufacturer of the product or the re-seller.
Standard Pack Products: It means products available in standard packs with product information in the form of Coded Information Label. Some examples are toothpaste pack of 200 grams, toothpaste pack of 100 grams, pack of 4 apples sold as such, a book etc.
Non Standard Pack Products: It refers products available in the quantity as needed by user e.g. fresh fruits are available as per the need of the user, some user may ask 300 grams and some may ask for 1250 grams, hence every time a customized coded information label is affixed on the product package, few examples many fruits are sold in loose form, vegetables and so on.
Product: It refers to standard pack product and/or non-standard pack product individually or collectively.
Geofenced facility: It refers to the geofencing the area/coordinates of the premises like a supermarket, retail store, warehouse, library or similar facility wherein the Standard pack and Non-Standard pack products are available to the users.

### BACKGROUND

Conventional multiproduct handling facilities like supermarket, libraries, warehouses etc. wherein products are available in standard and non-standard products have cumbersome process of check-out and billing. In case of standard pack products, the user has to pick-up the products and bring the products to the billing counter wherein the cashier checks the items needed by the user, scans them for pricing, billing and inventory management. The said scanner is configured to in-built software and at the billing counter reads the information of the standard pack products from the bar code/QR Code or similar code, communicates to its database and server, get the pricing and other relevant information, updates the inventory and bill gets ready. User pays for the bill and take possession of the products and moves out of the facility.

In case the user needs non-standard pack products, then user has to pick-up the desired quantity, brings it to the support staff at weighing machine, get it weighed and a bar code/QR Code or similar code label is printed and affixed on the primary package of the non-standard pack.

Sometimes non-standard pack products of different variety/category/prices are mixed and the store attendant has to segregate each product and then weighs each such category of products, resulting into delays due to different views of user and store attendant on the category of products.

In general, there is a long queue at both places i.e. billing counter and weighing station for packing of non-standard packs and due to various reasons users end up waiting for their turn and wasting their time.

Many times, people pick up a product from a shelf/bin and later keep them back at a different bin/location making it difficult to trace actual position of inventory in the facility and result into loss of sale.

Sometimes people ahead in the queue, keep adding/bringing additional items for billing and creates more discomfort.

Therefore, there is felt a need to provide a system that alleviates the afore-mentioned drawbacks.

### OBJECTS

Some of the objects of the present disclosure are described herein below:

An object of the present invention is to provide a system which helps the users to know the products available in the store once the user is physically in the store.

Another object of the present invention is to provide a system which helps the user to have real time information of its spend based on its selection of products and user spends minimum time during checks-out process, makes on-line payment without standing in long queues.

Another object of the present disclosure is to bring in additional checks at the time of check-out process and bring transparency, error free billing and user satisfaction.

Another object of the present disclosure is to assign the inventory of standard pack products in designated shelf/bin and make this information available to the user to get to the desired shelf/bin to pick the desired product.

Another object of the present disclosure is to trace the product when they are kept by users at a different location/bin then the one which is designated location for that product and make this real time information available to user/store staff to avoid loss of sales.

Another object of the present disclosure is to enhance productivity, with lesser involvement of humans for weighing, packing and billing counters.

Other objects and advantages of the present disclosure will be more apparent from the following description of the preferred embodiment as illustrated, which is not intended to limit the scope of the present disclosure.

### SUMMARY

The present invention relates to Artificial Intelligence Enabled Smart Inventory Management, Check-Out and Billing System.

According to an embodiment of the present invention, said system comprises a plurality of user devices associated with a plurality of users in one-to-one correspondence, server, camera for inside vigil of the geofenced facility, weighing & labeling counter, check-out and billing counter, conveyor belt mechanism multi layered shelf trolley and storage rack with bins.

In an embodiment, the user device is any electronic device having communication capabilities. In another embodiment, the user device is selected from the group, but not limited to, a mobile, a tablet, a laptop, a palmtop, a computing device, and a portable electronic device.

In an embodiment, the plurality of user devices is associated with a plurality of users in one-to-one correspondence. The user device has an application, with in-built graphical user interface, stored therein to facilitate the user to provide registration details like name, mobile number, age etc. to register with system.

In an embodiment, the user device is further configured to see the available products list, through the application saved in user device, and their bin number.

In an embodiment, the user device is further configured to facilitate the registered user to scan the coded information label affixed on standard pack products and non-standard pack products, pay for the bill on-line at the time of check-out and billing.

In an embodiment, the server is communicatively coupled with the user devices, camera, weighing & labeling counter and check-out cum billing counter.

In an embodiment, the server is configured with camera placed inside the geofenced facility to have a vigil on users inside the geofenced facility, various storage racks wherein standard pack products and non-standard pack products are kept.

In an embodiment, the server includes a repository, machine code generator and geofence generator.

In an embodiment, the machine code generator scans the coded information label on standard pack products and assign an internal code to said product and the said machine code generator also allows to generate internal codes for non-standard pack products.

In an embodiment, the repository is configured to store the location coordinates of various facilities to generate geofenced facilities.

In an embodiment, the repository is further configured to store information related to inventory of standard pack products as well as non-standard pack products like price per unit, weight, volume, batch number, manufacturing, best use before date, bin location etc.

In an embodiment, repository can be configured to store images of the standard pack-products and non-standard pack products linked with their respective internal code as generated by machine code generator.

In an embodiment, repository is further configured to store Unique Batch number creation rules.

In an embodiment, repository can be further configured to store bin location of each bin and further store a one-to-one QR Code/Bar Code or similar assigned to each bin of storage rack with bins.

In an embodiment, the weighing & Labeling counter is configured to a Camera, a weighing scale, a label printer, and packaging equipment.

In an embodiment, the camera is configured to an image identifier and image verifier.

In an embodiment, weighing scale is configured with a display screen to show the weight of the non-standard pack product as selected by user.

In an embodiment, Label printer is configured to print the coded information label of the non-standard pack product once the image of said product is verified by the image verifier, weight as measured by weighing counter and price to be billed as provided by repository.

In an embodiment, Packaging equipment is configured to an automated packaging material shelf to select the packaging material size to pack the non-standard pack product as per information used to print the coded information label, pack the non-standard pack product and affix the coded information label on it.

In an embodiment, Check Out & Billing counter is configured to a conveyor belt mechanism, weighing scale, a camera and a coded information label scanner.

In yet another embodiment, Check Out & Billing counter is configured to a large weighing scale and a coded information label scanner affixed on rotating/revolving/moving arms to reach into each shelf of the trolley to scan the products picked up by the user in the trolley.

In an embodiment, the reference numerals used in the description and drawing are implemented using one or more processor(s).

While the invention has been described and shown with particular reference to the preferred embodiment, it will be apparent that variations might be possible that would fall within the scope of the present invention.

### BRIEF DESCRIPTION OF ACCOMPANYING DRAWING

These and other features, aspects, and advantages of the present invention will become better understood with regard to the following description, appended claims, and accompanying drawings where:

FIG. 1A to 1D illustrates block diagrams of an Artificial Intelligence Enabled Smart Inventory Management, Check-Out And Billing System.

### LIST OF REFERENCE NUMERALS USED IN THE DESCRIPTION AND DRAWING

100—AI enabled smart check-out and billing system
200—User Device
300—Server
302—Repository
304—Machine Code generator
306—Geofence generator
308—Scanner for incoming inventory
400—Camera
500—Weighing & labeling counter
502—Camera for non-standard pack products
5022—Image Identifier
5024—Image Verifier
504—weighing scale
506—label printer
5062—Coded Information label
508—Coded Information label
510—packaging equipment
5102—packaging material shelf
600—Check-out & billing counter
612—weighing scale
614—coded information label scanner
616—large weighing scale
700—Conveyor Belt mechanism
800—Trolley (with adjustable shelf)
900—storage rack with bins

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof.

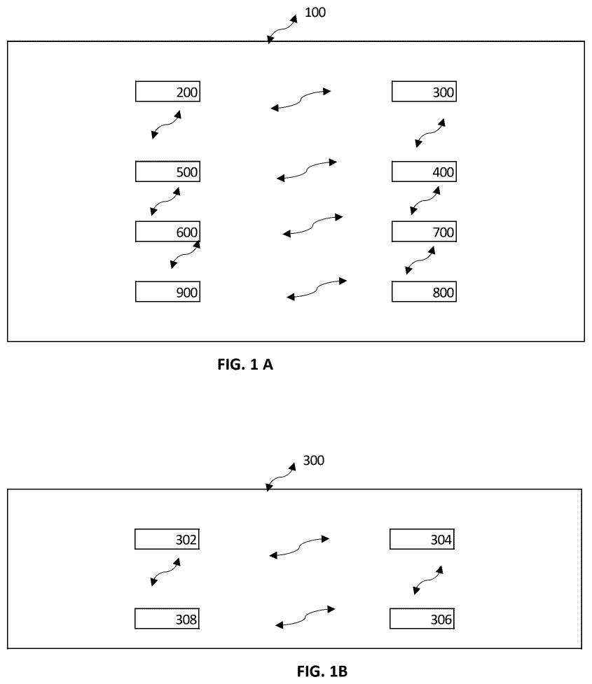

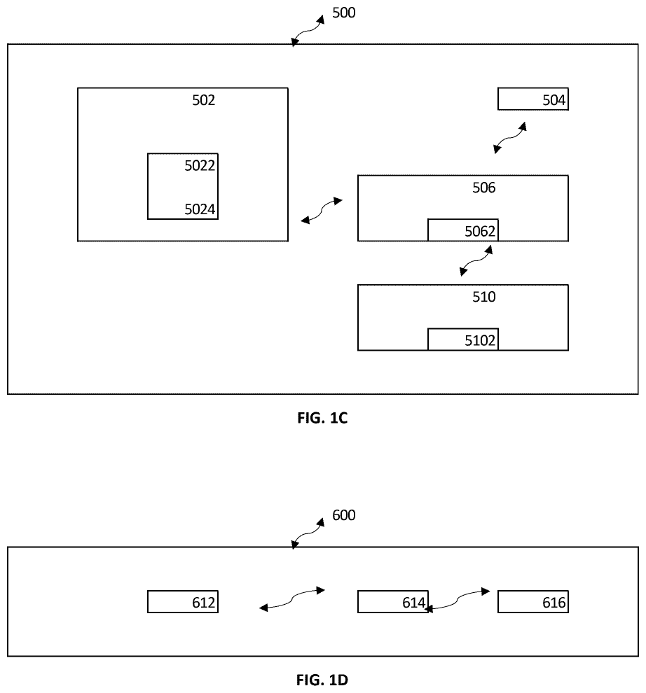

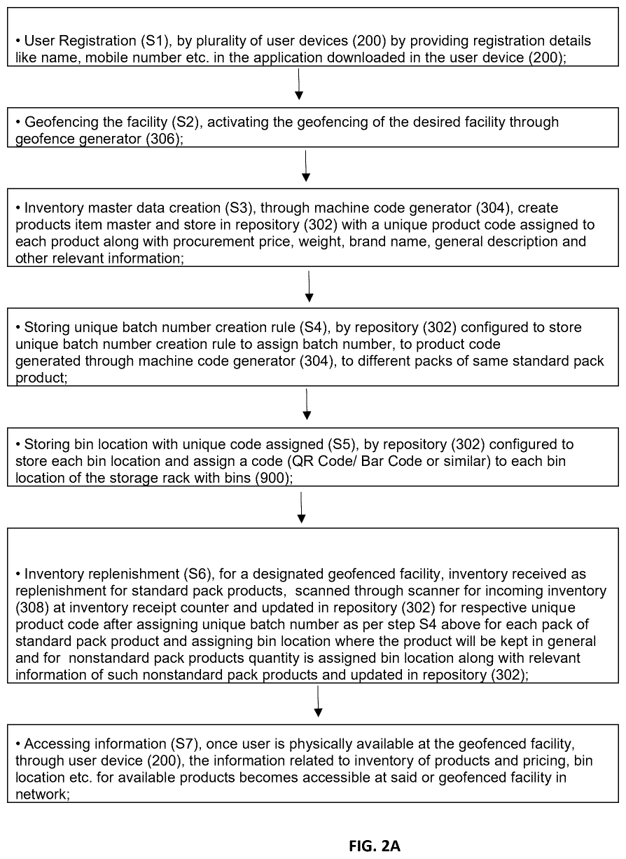

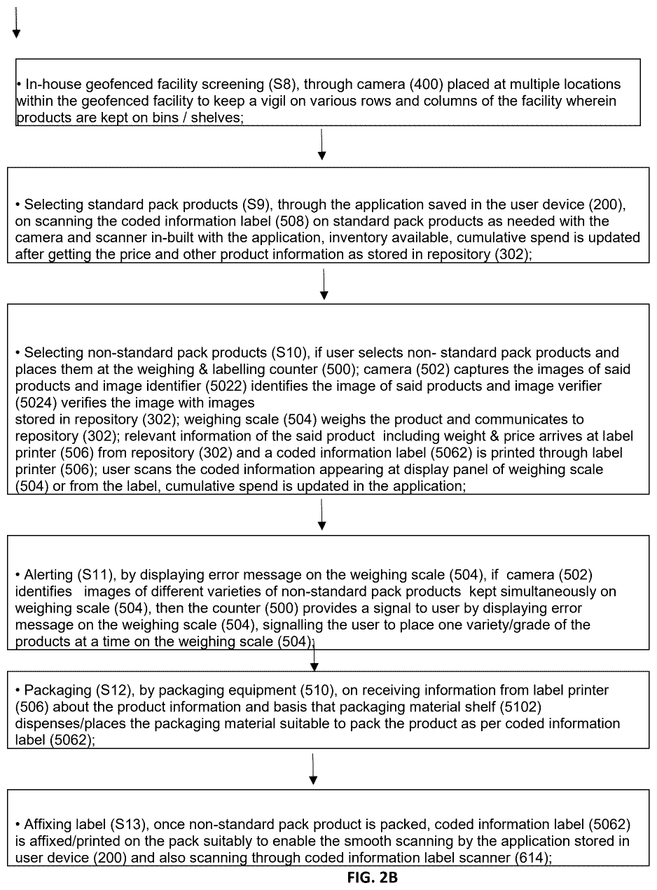

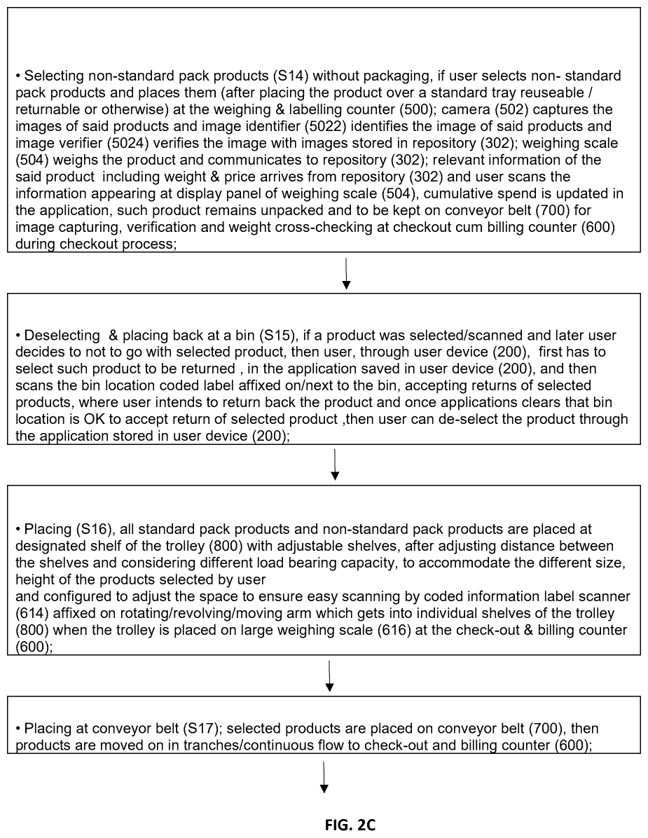

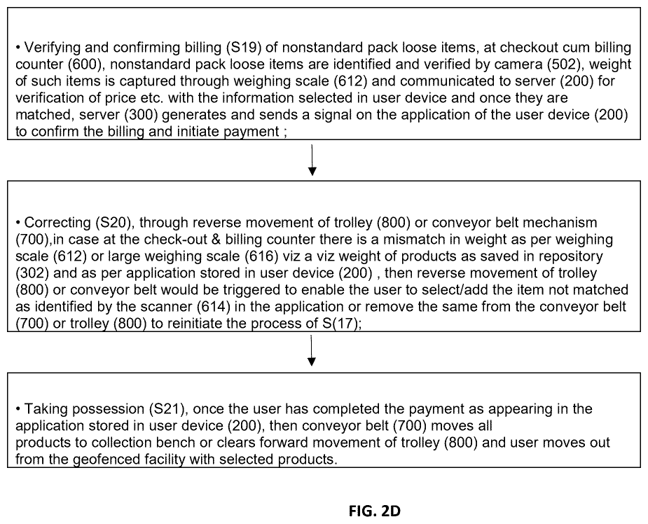

Artificial Intelligence Enabled Smart Inventory Management, Check-Out and Billing System, of the present disclosure is described with reference to FIG. 1A to 1D.

According to an embodiment of the present invention, said system (100) comprises a plurality of user devices (200) associated with a plurality of users in one-to-one correspondence, server (300), camera (400) for inside vigil of the geofenced facility, weighing & labeling counter (500), check-out and billing counter (600), conveyor belt mechanism (700) trolley with adjustable shelf (800) and storage rack with bins(900).

In an embodiment, the user device (200) is any electronic device having communication capabilities. In another embodiment, the user device (200) is selected from the group, but not limited to, a mobile, a tablet, a laptop, a palmtop, a computing device, and a portable electronic device.

The plurality of user devices (200) is associated with a plurality of users in one-to-one correspondence. The user device (200) has an application, with in-built graphical user interface, stored therein to facilitate the user to provide registration details like name, mobile number, age etc. to register with system (100).

The user device (200) is further configured to see the available products list, through the application saved in user device, and their bin number.

The user device (200) is further configured to facilitate the registered user to scan the coded information label (508) affixed on standard pack products and non-standard pack products, pay for the bill on-line at the time of check-out and billing.

The server (300) is communicatively coupled with the user devices (200), camera (400), weighing & labeling counter (500) and check-out cum billing counter (600).

The server (300) is configured with camera (400) placed inside the geofenced facility to have a vigil on users inside the geofenced facility, various storage racks wherein standard pack products and non-standard pack products are kept.

The server (300) includes a repository (302), machine code generator (304) and geofence generator (306).

The machine code generator (304) scans the coded information label on standard pack products and assign an internal code to said product and the said machine code generator (304) also allows to generate internal codes for non-standard pack products.

The repository (302) is configured to store the location coordinates of various facilities to generate geofenced facilities.

The repository (302) is further configured to store information related to inventory of standard pack products as well as non-standard pack products like price per unit, weight, volume, batch number, manufacturing, best use before date, bin location etc.

Repository (302) can be configured to store images of the standard pack-products and non-standard pack products linked with their respective internal code as generated by machine code generator (304).

Repository (302) is further configured to store Unique Batch number creation rules.

Repository (302) can be further configured to store bin location of each bin and further store a one-to-one QR Code/Bar Code or similar assigned to each bin of storage rack with bins (900).

The weighing & Labeling counter (500) is configured to a Camera (502), a weighing scale (504), a label printer (506) and packaging equipment (510).

The camera (502) is configured to an image identifier (5022) and image verifier (5024).

Weighing scale (504) is configured with a display screen to show the weight of the non-standard pack product as selected by user.

Label printer (506) is configured to print the coded information label (5062) of the non-standard pack product once the image of said product is verified by the image verifier (5024), weight as measured by weighing counter (504) and price to be billed as provided by repository (302).

Packaging equipment (510) is configured to an automated packaging material shelf (5102) to select the packaging material size to pack the non-standard pack product as per information used to print the coded information label (5062), pack the non-standard pack product, and affix the coded information label (5062) on it.

In an embodiment, Check Out & Billing counter (600) is configured to a conveyor belt (700), weighing scale (612), a camera (502) and a coded information label scanner (614).

In yet another embodiment, Check out & billing counter (600) is configured to a weighing scale (616) and a coded information label scanner (614) affixed on rotating/moving/revolving arms to reach into each shelf of the trolley (800) to scan the products placed by the user in the trolley with adjustable shelf (800).

In an embodiment, the reference numerals used in the description and drawing are implemented using one or more processor(s).

FIG. 2A to 2D illustrates a flow diagram of an AI enabled smart inventory management, check-out and billing system (100).

The steps include:
User Registration (S1), by plurality of user devices (200) by providing registration details like name, mobile number etc. in the application downloaded in the user device (200);
Geofencing the facility (S2), activating the geofencing of the desired facility through geofence generator (306);
Inventory master data creation (S3), through machine code generator (304), create products item master and store in repository (302) with a unique product code assigned to each product along with procurement price, weight, brand name, general description and other relevant information;
Storing unique batch number creation rule (S4), by repository (302) configured to store unique batch number creation rule to assign batch number, to product code generated through machine code generator (304), to different packs of same standard pack product;
Storing bin location with unique code assigned (S5), by repository (302) configured to store each bin location and assign a code (QR Code/Bar Code or similar) to each bin location of the storage rack with bins (900);
Inventory replenishment (S6), for a designated geofenced facility, inventory received as replenishment for standard pack products, scanned through scanner for incoming inventory (308) at inventory receipt counter and updated in repository (302) for respective unique product code after assigning unique batch number as per step S4 above for each pack of standard pack product and assigning bin location where the product will be kept in general and for nonstandard pack products quantity is assigned bin location along with relevant information of such nonstandard pack products and updated in repository (302);
Accessing information (S7), once user is physically available at the geofenced facility, through user device (200), the information related to inventory of products and pricing, bin location etc. for available products becomes accessible at said or geofenced facility in network;
In-house geofenced facility screening (S8), through camera (400) placed at multiple locations within the geofenced facility to keep a vigil on various rows and columns of the facility wherein products are kept on bins/shelves;
Selecting standard pack products (S9), through the application saved in the user device (200), on scanning the coded information label (508) on standard pack products as needed with the camera and scanner in-built with the application, inventory available, cumulative spend is updated after getting the price and other product information as stored in repository (302);
Selecting non-standard pack products (S10), if user selects non-standard pack products and places them at the weighing & labelling counter (500); camera (502) captures the images of said products and image identifier (5022) identifies the image of said products and image verifier (5024) verifies the image with images stored in repository (302); weighing scale (504) weighs the product and communicates to repository (302); relevant information of the said product including weight & price arrives at label printer (506) from repository (302) and a coded information label (5062) is printed through label printer (506); user scans the coded information appearing at display panel of weighing scale (504) or from the label, cumulative spend is updated in the application;
Alerting (S11), by displaying error message on the weighing scale (504), if camera (502) identifies images of different varieties of non-standard pack products kept simultaneously on weighing scale (504), then the counter (500) provides a signal to user by displaying error message on the weighing scale (504), signalling the user to place one variety/grade of the products at a time on the weighing scale (504);
Packaging (S12), by packaging equipment (510), on receiving information from label printer (506) about the product information and basis that packaging material shelf (5102) dispenses/places the packaging material suitable to pack the product as per coded information label (5062);
Affixing label (S13), once non-standard pack product is packed, coded information label (5062) is affixed/printed on the pack suitably to enable the smooth scanning by the application stored in user device (200) and also scanning through coded information label scanner (614);
Selecting non-standard pack products (S14) without packaging, if user selects non-standard pack products and places them (after placing the product over a standard tray reuseable/returnable or otherwise) at the weighing & labelling counter (500); camera (502) captures the images of said products and image identifier (5022) identifies the image of said products and image verifier (5024) verifies the image with images stored in repository (302); weighing scale (504) weighs the product and communicates to repository (302); relevant information of the said product including weight & price arrives from repository (302) and user scans the information appearing at display panel of weighing scale (504), cumulative spend is updated in the application, such product remains unpacked and to be kept on conveyor belt (700) for image capturing, verification and weight cross-checking at checkout cum billing counter (600) during checkout process;
Deselecting & placing back at a bin (S15), if a product was selected/scanned and later user decides to not to go with selected product, then user, through user device (200), first has to select such product to be returned, in the application saved in user device (200), and then scans the bin location coded label affixed on/next to the bin, accepting returns of selected products, where user intends to return back the product and once applications clears that bin location is OK to accept return of selected product, then user can de-select the product through the application stored in user device (200);
Placing (S16), all standard pack products and non-standard pack products are placed at designated shelf of the trolley (800) with adjustable shelves, after adjusting distance between the shelves and considering different load bearing capacity, to accommodate the different size, height of the products selected by user and configured to adjust the space to ensure easy scanning by coded information label scanner (614) affixed on rotating/revolving/moving arm which gets into individual shelves of the trolley (800) when the trolley is placed on large weighing scale (616) at the check-out & billing counter (600);
Placing at conveyor belt (S17); selected products are placed on conveyor belt (700), then products are moved on in tranches/continuous flow to check-out and billing counter (600);
Verifying and confirming billing (S18) of standard pack or non-standard pack labelled items, at check-out and billing counter (600) coded information label scanner (614) scans the information on the coded information label (508) and/or (5062) including pricing and weight and communicates to server (300), to verify with the weight of all such products as measured and communicated to server (300) by weighing scale (612) or large weighing scale (616) and once they are matched, server (300) generates and sends a signal on the application of the user device (200) to confirm the billing and initiate payment;
Verifying and confirming billing (S19) of nonstandard pack loose items, at checkout cum billing counter (600), nonstandard pack loose items are identified and verified by camera (502), weight of such items is captured through weighing scale (612) and communicated to server (200) for verification of price etc. with the information selected in user device and once they are matched, server (300) generates and sends a signal on the application of the user device (200) to confirm the billing and initiate payment;
Correcting (S20), through reverse movement of trolley (800) or conveyor belt mechanism (700), in case at the check-out & billing counter there is a mismatch in weight as per weighing scale (612) or large weighing scale (616) viz a viz weight of products as saved in repository (302) and as per application stored in user device (200), then reverse movement of trolley (800) or conveyor belt would be triggered to enable the user to select/add the item not matched as identified by the scanner (614) in the application or remove the same from the conveyor belt (700) or trolley (800) to reinitiate the process of S(17);
Taking possession (S21), once the user has completed the payment as appearing in the application stored in user device (200), then conveyor belt (700) moves all
products to collection bench or clears forward movement of trolley (800) and user moves out from the geofenced facility with selected products.

### Technical Advancements and Economical Significance

The present disclosure described herein above has several technical advantages including, but not limited to, the realization of automated inventory management, check-out and billing process with lesser manual efforts, which:
Real time status of availability of the products at the geofenced facility;
Minimizes errors of products picked up by user and billed for;
Real time information to the user about the cumulative spend as the user selects additional products;
Changing the products selected if user decides to go for different make and model of the product without hassles of coming out from the queue and coming back in queue again.
Avoidance of last minute scanning errors at check-out & billing counter, resulting into going back to the designated shelf and selecting other pack of same make and model;
Ease of traceability of products in case a product is selected by a user from a bin and kept back at other designated bins;
Payment for right grade of loose product selected without human involvements.
Optimized sized packaging materials used for loose products.
Longer hours for such geofenced facilities to serve users.
   The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The use of the expression “at least” or “at least one” suggests the use of one or more elements or ingredients or quantities, as the use may be in the embodiment of the disclosure to achieve one or more of the desired objects or results.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system (100) for Artificial Intelligence enabled smart inventory management, check-out and billing system, said system (100) comprising:
a plurality of user devices (200) associated with a plurality of users in one-to-one correspondence, said user device (102) having an application stored therein to facilitate said user to provide registration details and to facilitate said registered user to get status of available products and bin locations thereof in the geofenced facility;
camera (400), configured in the geofenced facility at such locations, to have a complete vigil on storage racks with bins (900) and users in the facility;
weighing & labelling counter (500), to weigh the non-standard pack product, display price and relevant information on display panel to be scanned through user device (200), and get the said product packed and labelled, if needed;
check-out cum billing counter (600), to verify the product selected by user, generate invoice and on receipt of payment allow the delivery of products to user;
conveyor belt mechanism (700), to convey products placed by user for verification at the check-out cum billing counter (600);
trolley with adjustable shelf (800), to convey products placed by user for verification at the check-out cum billing counter (600) without individually taking them out for verification;
storage rack with bins (900), to pick up & return the products by users, as placed by geofenced facility staff; and
a server (300), communicatively coupled with the user devices (200), camera (400), weighing & labelling counter (500), check-out cum billing counter (600), and storage rack with bins (900), wherein said server (300) includes;
a repository (302) which is configured to store:
the location coordinates of various facilities to generate geofenced facility;
real-time information related to inventory of standard pack products as well as non-standard pack products like price per unit, weight, volume, batch number, manufacturing, best use before date, bin location etc.;
images of the standard pack-products and non-standard pack products linked with their respective internal code as generated by machine code generator (304);
Unique Batch number creation rules;
Bin location of each bin and store a one-to-one QR Code/Bar Code or similar assigned to each bin of storage rack with bins (900)
a machine code generator (304):
configured to scan the coded information label on standard pack products and assign an internal code to said product and the said machine code generator (304) also allows to generate internal codes for non-standard pack products;
a geofence generator (306):
configured to create geofence of desired facility, wherein a user device (200) once physically present would be able to get product availability and storage bin information of said and all other geofenced facilities in the network.

2. The system (100) as claimed in claim 1, wherein weighing & labelling counter (500) is configured to:
a Camera (502), characterized in that, an image identifier (5022) configured to identify the image of the non-standard pack product, and an image verifier (5024) configured to verify the image with the repository (302) and configured to communicate the result to server (300);
a weighing scale (504), characterized in that a display screen to show the weight, price of the non-standard pack product along with QR Code/Bar Code or similar, when said products are kept, with/without a tray/bucket reusable or otherwise, on said weighing scale (504), as selected by the user;
a label printer (506), to generate & display on the weighing scale (504), the coded information label (5062) of the non-standard pack product, once the image of said product is verified by the image verifier (5024), weight as measured by weighing counter (504) and price to be billed as provided by repository (302); and
packaging equipment (510), configured to an automated packaging material shelf (5102) to select the packaging material to pack the non-standard pack product as per information used to print the coded information label (5062) and scanned by user device (200), pack the non-standard pack product and affix/print the coded information label (5062) on the pack.

3. The system (100) as claimed in claim 1, wherein check-out cum billing counter (600) is configured:
to a conveyor belt mechanism (700), having a QR Code label/bar code label or similar code configured on a one-to-one correspondence, to activate the said conveyor belt mechanism (700) on scanning the label by user device (200), to convey the products to the coded information label scanner (614) and then to weighing scale (612) in same or different order;
to a weighing scale (612) to weight the product coming to it via conveyor belt and communicate to server (300);
to a coded information label scanner (614), to read/scan the coded information label (5062)/(508) to get weight of the products selected by user in the application stored in user device (200), communicate to server (300) and cross check the information of products selected and their weight through weighing scale (612);
a Camera (502), characterized in that, an image identifier (5022) configured to identify the image of the non-standard pack product in loose form, and an image verifier (5024) configured to verify the image with the repository (302) and configured to communicate the result to server (300) and cross check the information of products selected and their weight through weighing scale (612);
to a Check out & billing counter (600), configured to a large weighing scale (616) to measure total net weight of all products in the trolley (800) and a coded information label scanner (614) affixed on rotating/moving/revolving arms to reach into each shelf layer of the trolley (800) to scan the labels on the products picked up by the user in the trolley (800) for verification, without the need of taking them out and placing them on the conveyor belt.

4. The system (100) as claimed in claim 1, wherein trolley with adjustable shelf (800) is configured to make shelves adjustable (aligning distance/height between the shelf and different load bearing capacity of the shelf) to accommodate the different size, height of the products selected by user and making available space to scanner (614) to move in between the layer of shelf to scan coded information label (508) and/or (5062) affixed on products.

5. A method for an Artificial Intelligence enabled smart inventory management, check-out and billing, said method comprises the following steps:
User Registration (S1), by plurality of user devices (200) by providing registration details like name, mobile number etc. in the application downloaded in the user device (200);
Geofencing the facility (S2), activating the geofencing of the desired facility through geofence generator (306);
Inventory master data creation (S3), through machine code generator (304), create products item master and store in repository (302) with a unique product code assigned to each product along with procurement price, weight, brand name, general description and other relevant information;
Storing unique batch number creation rule (S4), by repository (302) configured to store unique batch number creation rule to assign batch number, to product code generated through machine code generator (304), to different packs of same standard pack product;
Storing bin location with unique code assigned (S5), by repository (302) configured to store each bin location and assign a code (QR Code/Bar Code or similar) to each bin location of the storage rack with bins (900);
Inventory replenishment (S6), for a designated geofenced facility, inventory received as replenishment for standard pack products, scanned through scanner for incoming inventory (308) at inventory receipt counter and updated in repository (302) for respective unique product code after assigning unique batch number as per step S4 above for each pack of standard pack product and assigning bin location where the product will be kept in general and for nonstandard pack products quantity is assigned bin location along with relevant information of such nonstandard pack products and updated in repository (302);
Accessing information (S7), once user is physically available at the geofenced facility, through user device (200), the information related to inventory of products and pricing, bin location etc. for available products becomes accessible at said or geofenced facility in network;
In-house geofenced facility screening (S8), through camera (400) placed at multiple locations within the geofenced facility to keep a vigil on various rows and columns of the facility wherein products are kept on bins/shelves;
Selecting standard pack products (S9), through the application saved in the user device (200), on scanning the coded information label (508) on standard pack products as needed with the camera and scanner in-built with the application, inventory available, cumulative spend is updated after getting the price and other product information as stored in repository (302);
Selecting non-standard pack products (S10), if user selects non-standard pack products and places them at the weighing & labelling counter (500); camera (502) captures the images of said products and image identifier (5022) identifies the image of said products and image verifier (5024) verifies the image with images stored in repository (302); weighing scale (504) weighs the product and communicates to repository (302); relevant information of the said product including weight & price arrives at label printer (506) from repository (302) and a coded information label (5062) is printed through label printer (506); user scans the coded information appearing at display panel of weighing scale (504) or from the label, cumulative spend is updated in the application;
Alerting (S11), by displaying error message on the weighing scale (504), if camera (502) identifies images of different varieties of non-standard pack products kept simultaneously on weighing scale (504), then the counter (500) provides a signal to user by displaying error message on the weighing scale (504), signalling the user to place one variety/grade of the products at a time on the weighing scale (504);
Packaging (S12), by packaging equipment (510), on receiving information from label printer (506) about the product information and basis that packaging material shelf (5102) dispenses/places the packaging material suitable to pack the product as per coded information label (5062);
Affixing label (S13), once non-standard pack product is packed, coded information label (5062) is affixed/printed on the pack suitably to enable the smooth scanning by the application stored in user device (200) and also scanning through coded information label scanner (614);
Selecting non-standard pack products (S14) without packaging, if user selects non-standard pack products and places them (after placing the product over a standard tray reuseable/returnable or otherwise) at the weighing & labelling counter (500); camera (502) captures the images of said products and image identifier (5022) identifies the image of said products and image verifier (5024) verifies the image with images stored in repository (302); weighing scale (504) weighs the product and communicates to repository (302); relevant information of the said product including weight & price arrives from repository (302) and user scans the information appearing at display panel of weighing scale (504), cumulative spend is updated in the application, such product remains unpacked and to be kept on conveyor belt (700) for image capturing, verification and weight cross-checking at checkout cum billing counter (600) during checkout process;
Deselecting & placing back at a bin (S15), if a product was selected/scanned and later user decides to not to go with selected product, then user, through user device (200) first has to select such product to be returned, in the application saved in user device (200), and then scans the bin location coded label affixed on/next to the bin, accepting returns of selected products, where user intends to return back the product and once applications clears that bin location is OK to accept return of selected product, then user can de-select the product through the application stored in user device (200);
Placing (S16), all standard pack products and non-standard pack products are placed at designated shelf of the trolley (800) with adjustable shelves, after adjusting distance between the shelves and considering different load bearing capacity, to accommodate the different size, height of the products selected by user and configured to adjust the space to ensure easy scanning by coded information label scanner (614) affixed on rotating/revolving/moving arm which gets into individual shelves of the trolley (800) when the trolley is placed on large weighing scale (616) at the check-out & billing counter (600);
Placing at conveyor belt (S17); selected products are placed on conveyor belt (700), then products are moved on in tranches/continuous flow to check-out and billing counter (600);
Verifying and confirming billing (S18) of standard pack or non-standard pack labelled items, at check-out and billing counter (600) coded information label scanner (614) scans the information on the coded information label (508) and/or (5062) including pricing and weight and communicates to server (300), to verify with the weight of all such products as measured and communicated to server (300) by weighing scale (612) or large weighing scale (616) and once they are matched, server (300) generates and sends a signal on the application of the user device (200) to confirm the billing and initiate payment;
Verifying and confirming billing (S19) of nonstandard pack loose items, at checkout cum billing counter (600), nonstandard pack loose items are identified and verified by camera (502), weight of such items is captured through weighing scale (612) and communicated to server (200) for verification of price etc. with the information selected in user device and once they are matched, server (300) generates and sends a signal on the application of the user device (200) to confirm the billing and initiate payment;
Correcting (S20), through reverse movement of trolley (800) or conveyor belt mechanism (700), in case at the check-out & billing counter there is a mismatch in weight as per weighing scale (612) or large weighing scale (616) viz a viz weight of products as saved in repository (302) and as per application stored in user device (200), then reverse movement of trolley (800) or conveyor belt would be triggered to enable the user to select/add the item not matched as identified by the scanner (614) in the application or remove the same from the conveyor belt (700) or trolley (800) to reinitiate the process of S(17);
Taking possession (S21), once the user has completed the payment as appearing in the application stored in user device (200), then conveyor belt (700) moves all products to collection bench or clears forward movement of trolley (800) and user moves out from the geofenced facility with selected products.
